(19) United States
(12) Patent Application Publication
(10) Pub. No.: US 2009/0243712 A1
(43) Pub. Date: Oct. 1, 2009

(54) Device for reducing power consumption inside integrated circuit

(75) Inventor: Yun-Chi Chiang, Zhubei City (TW)

Correspondence Address: Tung & Associates, Suite 120, 838 W. Long Lake Raod, Bloomfield Hills, MI, 48302, US

(73) Assignee: Richtek Technology Corporation

(21) Appl. No.: 12/378,113

(22) Filed: Feb. 11, 2009

(30) Foreign Application Priority Data
Apr. 1, 2008 (TW) 097205562

(51) Int. Cl. G05F 1/10

(52) U.S. Cl. 327/541

(57) ABSTRACT

The present invention discloses a device for reducing power consumption inside an integrated circuit (IC), comprising: an IC including an up-gate transistor and a low-gate transistor electrically connected with each other, and a control circuit controlling the up-gate transistor and the low-gate transistor; and a resistor located outside the IC, the resistor having one end electrically connected with a node between the up-gate transistor and the low-gate transistor, or electrically connected with an upper end of the up-gate transistor.

### BACKGROUND OF THE INVENTION

1. Field of Invention

The present invention relates to a device for reducing power consumption inside an integrated circuit (IC).

2. Description of Related Art

There are several kinds of power management circuits which supply voltage outputs by means of switching of an up-gate transistor and a low-gate transistor, such as the buck voltage regulator as shown in FIG. 1. FIG. 2 is another example which shows a power management circuit for liquid crystal display (LCD); it also supplies a voltage output by switching of an up-gate transistor and a low-gate transistor. More specifically, as shown in FIG. 2, the circuit includes a controller 11 and two transistors T1 and T2, which are integrated inside an IC 10. A node VGHM between the transistors T1 and T2 provides a voltage output to a gate driver circuit of an LCD. In addition to the above, the circuit further includes a resistor R1, which is a discrete device separated from the IC. The function of the resistor R1 is to create a corner-rounding shape as shown in FIG. 3 onto the voltage at the node VGHM, so as to provide better control voltage to the cells in the liquid crystal array. The voltage at the node VGHM varies between its high level V1 and low level V0.

Because the up-gate and low-gate transistors are packaged inside the IC, heat dissipation issue is a concern that limits the power consumption inside the IC, and also brings difficulty to a circuit designer.

### SUMMARY OF THE INVENTION

An objective of the present invention is to move part of the power consumption outside the IC, so that there is less heat dissipation issue inside the IC. Moreover, the present invention also provides a circuit structure to fulfill the requirement for corner-shaping as shown in FIG. 3.

In accordance with the foregoing and other objectives, in one aspect, the present invention discloses a device for reducing power consumption inside an IC, comprising: an IC including an up-gate transistor and a low-gate transistor electrically connected with each other, and a control circuit controlling the up-gate transistor and the low-gate transistor; and a resistor located outside the IC, the resistor having one end electrically connected with a node between the up-gate transistor and the low-gate transistor, or electrically connected with an upper end of the up-gate transistor.

The IC for example is an LCD power management circuit or a switching regulator

It is to be understood that both the foregoing general description and the following detailed description are provided as examples, for illustration but not for limiting the scope of the invention.

### BRIEF DESCRIPTION OF THE DRAWINGS

These and other features, aspects, and advantages of the present invention will become better understood with regard to the following description, appended claims, and accompanying drawings.

FIG. 1 is a schematic circuit diagram showing a conventional buck switching regulator.

FIG. 2 is a schematic circuit diagram showing a conventional LCD power management circuit.

FIG. 3 shows the voltage waveform at the node VGHM of FIG. 2.

FIGS. 4 and 5 explain the power consumption on the charge and discharge paths.

FIGS. 6-8 show three embodiments of the present invention.

FIG. 9 shows an example as to how to obtain a feedback signal from the node VGHM.

FIGS. 10 and 11 show the voltage waveforms at the node VGHM of different embodiments of the present invention.

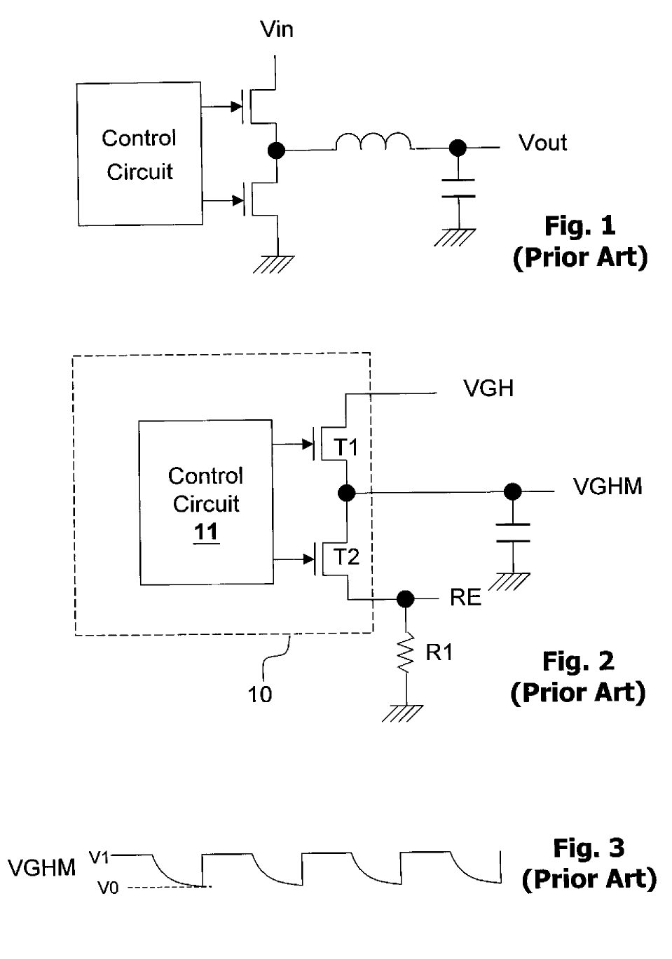

### DESCRIPTION OF THE PREFERRED EMBODIMENTS

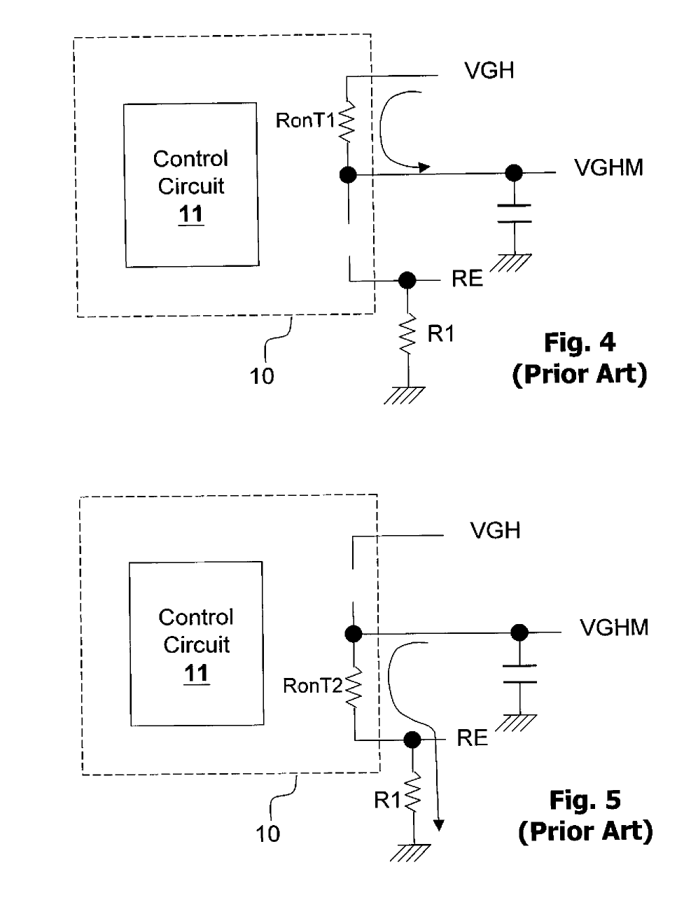

The present invention will be explained with respect to its concept first. Referring to FIG. 4, in the charging period when the up-gate transistor T1 is ON and the low-gate transistor T2 is OFF, the up-gate transistor T1 has a conduction resistance RonT1; the power consumed within the whole charging period is C*(V₁−V₀)²/2*f, wherein C is the capacitance, f is the switching frequency. Also referring to FIG. 5, in the discharging period when the up-gate transistor T1 is OFF and the low-gate transistor T2 is ON, the low-gate transistor T2 has a conduction resistance RonT2; the power consumed within the whole discharging period is C*(V₁²−V₀²)/2*f. As the waveform at the node VGHM is as shown in FIG. 3, the total power consumption in a full period is

C*(V₁−V₀)²/2*f+C*(V₁²−V₀²)/2*f=C*V₁*(V₁−V₀)*f

And it can be found from the equation that the power consumption is irrelevant to the resistance on the charge and discharge paths.

Since the power consumption is irrelevant to the resistance on the charge and discharge paths, the present invention proposes to provide a resistor on the charge path and/or the discharge path, but external to the IC. Thus, part of the power consumption takes place outside of the IC and this solves the heat dissipation issue inside the IC package. Moreover, optionally, the conduction resistance of the up-gate transistor or the low-gate transistor may be decreased, or the resistance of the external resistance may be increased.

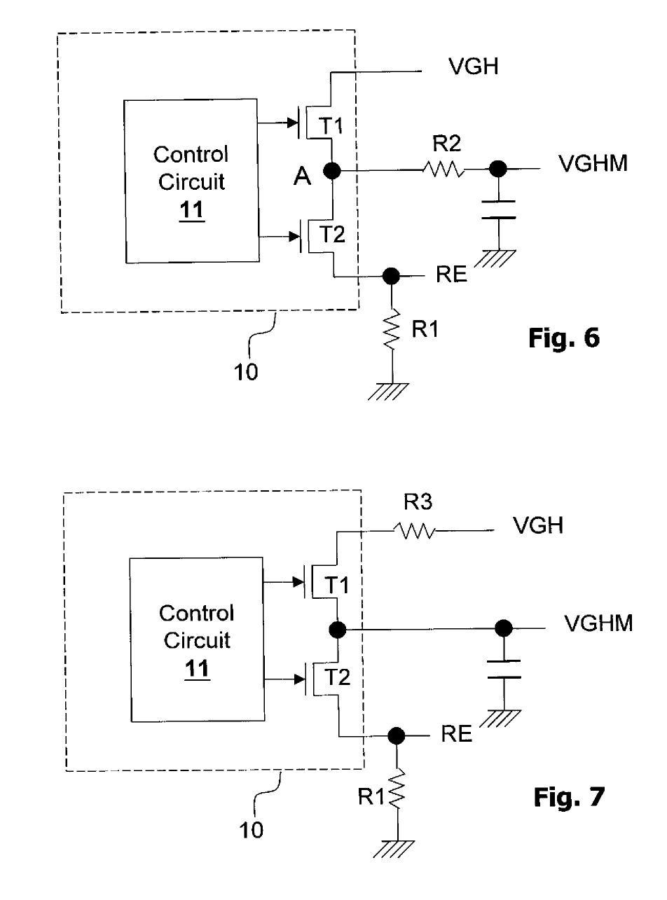

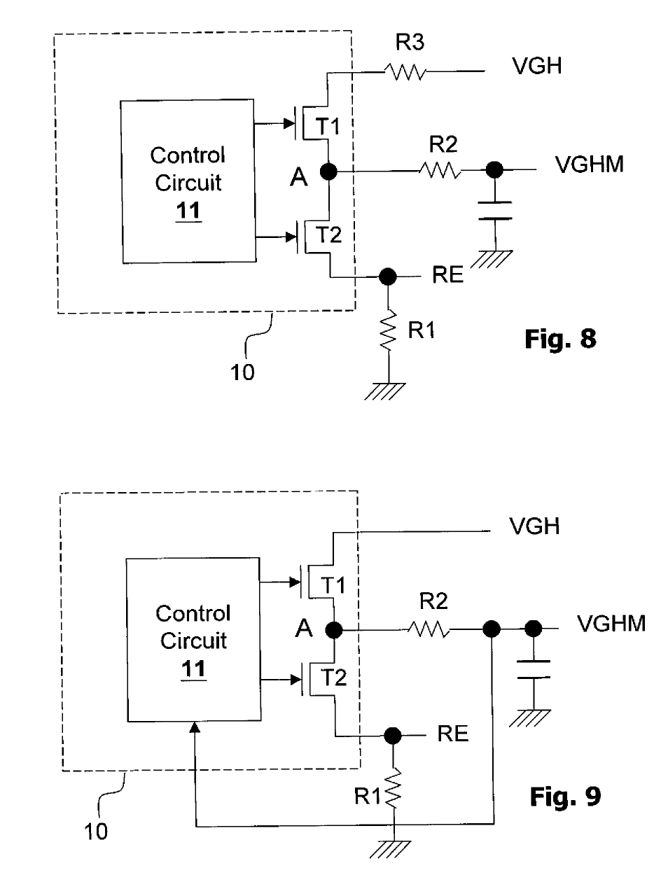

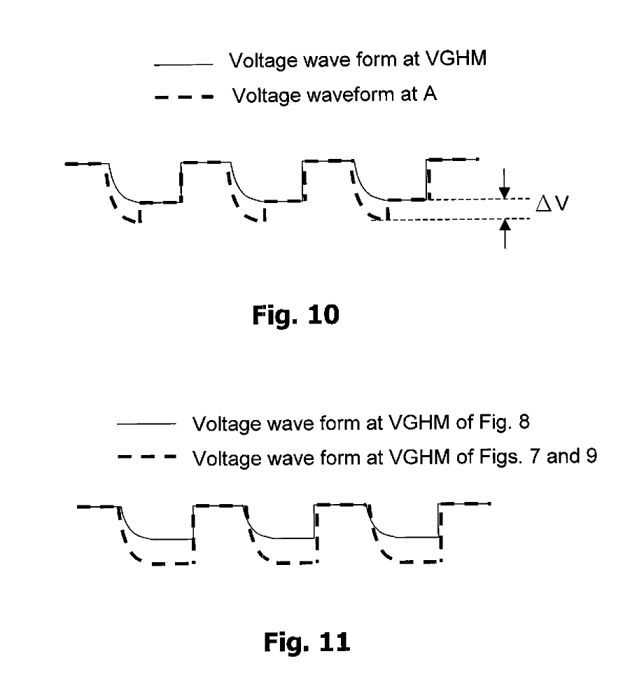

FIGS. 6-8 show three embodiments according to the present invention: a resistor R2 is provided between the node A between the transistors T1 and T2 and the output node VGHM (FIG. 6); a resistor R3 is provided at the upper end of the transistor T1, i.e., between the transistor T1 and a voltage supply VGH (FIG. 7); or both the resistors R2 and R3 are provided. Because the resistors R2 and R3 are external to the IC, the heat inside the IC package can be effectively moved outside of the IC for better dissipation. As to the conduction resistance of the up-gate and low-gate transistors T1 and T2, and the resistance of the external resistor R1, they can be adjusted or kept unadjusted according to the requirement to the circuit. FIG. 11 shows the difference between the waveforms of the voltages at the node VGHM in the embodiments of FIGS. 7 and 8, wherein the thick dash line shows the waveform in FIG. 7 and the thin solid line shows the waveform in FIG. 8.

Note that in the structure of FIG. 6 or 8, because a resistor R2 is provided, if a feedback signal is to be obtained from the output to control the circuit inside the IC, the signal should be obtained from the node VGHM, not the node A. FIG. 9 shows a circuit embodiment to obtain such feedback signal. Referring to FIG. 10, before the low-gate transistor T2 is OFF, the current on the resistor R2 will generate a voltage difference ΔV, and thus the signal obtained from the node VGHM is more accurate. In FIG. 10, the thick dash line shows the waveform of the voltage at the node A in FIG. 9 and the thin solid line shows the waveform of the voltage at the node VGHM in FIG. 9.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the present invention is not limited to the application of LCD power management circuits; it can be applied to any other kind of circuits which involve switching of an up-gate transistor and a low-gate transistor. Therefore, the spirit of the present invention should cover all such and other modifications and variations, which should be interpreted to fall within the scope of the following claims and their equivalents.

What is claimed is:

1. A device for reducing power consumption inside an integrated circuit (IC), comprising:
an IC including an up-gate transistor and a low-gate transistor electrically connected with each other, and a control circuit controlling the up-gate transistor and the low-gate transistor; and
a first resistor located outside the IC, the first resistor having one end electrically connected with a node between the up-gate transistor and the low-gate transistor.

2. The device of claim 1, wherein the other end of the first resistor is electrically connected with a voltage output node.

3. The device of claim L, wherein the IC is a liquid crystal display power management circuit or a switching regulator.

4. The device of claim 1, further comprising a second resistor located outside the IC, the second resistor being electrically connected with an upper end of the up-gate transistor.

5. The device of claim 2, wherein the low-gate transistor is turned OFF according to a voltage at the voltage output node.

6. A device for reducing power consumption inside an integrated circuit (IC), comprising:
an IC including an up-gate transistor and a low-gate transistor electrically connected with each other, and a control circuit controlling the up-gate transistor and the low-gate transistor; and
a first resistor located outside the IC, the first resistor having one end electrically connected with an upper end of the up-gate transistor.

7. The device of claim 6, wherein the other end of the first resistor is electrically connected with a voltage supply.

8. The device of claim 6, wherein the IC is a liquid crystal display power management circuit or a switching regulator.

9. The device of claim 6, further comprising a second resistor located outside the IC, the second resistor having one end electrically connected with a node between the up-gate transistor and the low-gate transistor.

10. The device of claim 9, wherein the other end of the second resistor is electrically connected with a voltage output node, and wherein the low-gate transistor is turned OFF according to a voltage at the voltage output node.
